(19) United States
(12) Patent Application Publication
(10) Pub. No.: US 2003/0074272 A1
(43) Pub. Date: Apr. 17, 2003

(54) System and method for distributing product hazard information

(76) Inventors: William A. Knegendorf, Saunderstown, RI (US); Daniel Kaplan, Barrington, RI (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/101,555

(22) Filed: Mar. 18, 2002

Related U.S. Application Data
(60) Provisional application No. 60/276,676, filed on Mar. 16, 2001.
(60) Provisional application No. 60/281,520, filed on Apr. 4, 2001.

(51) Int. Cl. G06F 17/60

(52) U.S. Cl. 705/26

(57) ABSTRACT

A system is provided that distributes product hazard information to a user for products in which that particular user is interested. Furthermore, the system may keep track of access information including the product hazard notices that have been provided to each user, as well as information about what user received a particular notice and when they received it. This information may be kept for a long period of time, and may be made available in case of a future litigation or other court action compelling disclosure. In addition to providing product hazard information to the consumers, such a system may provide users with fulfillment information about products for which recall notices have been issued, or to provide links directly to appropriate fulfillment companies' web pages.

### RELATED APPLICATIONS

This application claims the benefit under Title 35 U.S.C. §119(e) of co-pending U.S. Provisional Application Serial No. 60/276,676, filed Mar. 16, 2001, entitled “METHODS AND APPARATUS FOR IMPROVED COLLECTION, HANDLING AND DISSEMINATION OF CONSUMER PRODUCT SAFETY INFORMATION” by Daniel Kaplan, David P. Goldsmith, and William A. Knegendorf, and U.S. Provisional Application Serial No. 60/281,520, filed Apr. 4, 2001, entitled “METHODS AND APPARATUS FOR IMPROVED COLLECTION, HANDLING AND DISSEMINATION OF CONSUMER PRODUCT SAFETY INFORMATION” by Daniel Kaplan, David P. Goldsmith, and William A. Knegendorf, both of which applications are incorporated by reference herein.

### FIELD OF THE INVENTION

This application pertains generally to distributing product information, and, more particularly to a computer-implemented system and method for distributing product hazard information.

### BACKGROUND

Thousands of new products are produced daily and released into the stream of commerce by manufacturers. Some of these products are later found to be defective or dangerous to consumers. Occasionally a manufacturer may learn about a defect from customers or one of the product distributors; sometimes the defect becomes apparent during the post-production testing or prolonged product use, and sometimes it may be discovered after an accident or a malfunction.

If a particular kind of product is found to have a common flaw that is hazardous, a manufacturer may issue a product hazard information notice, in which detailed information regarding the flaw is provided and either a method of fixing the flaw is described, or consumers who purchased the product may be directed to exchange it at the place of purchase or return it to the manufacturer. This process is sometimes referred to as a “product recall,” because the manufacturer is recalling the product and offers to supply the affected consumers with a safer version of the product or monetary compensation.

Even after the manufacturer announces a recall, there is a danger that the notice will not reach the affected consumers because there is no adequate method for identifying consumers that are currently using the products. Product hazard information notices may be sent to product distributors. High-profile recalls, such as, for example, those that cause death, may be mentioned in television programs or newspaper articles, but even for those products there is no guarantee that the information will reach all relevant consumers. Additionally, information distributed by newspapers often contains only an indication of a product that is being recalled, and not directions for what a consumer should do in connection with this recall.

Statistics show that even in high-profile recalls, such as those that have been featured on television or in newspapers, less than half of the products are properly returned to the manufacturer over the lifetime of the product. Returning the product to the manufacturer or exchanging it for another product, as specified by the recall notice, is called “fulfilling” that recall. Typically, manufacturers hire special companies called “fulfillment companies” or “reverse distribution companies” who are experts in the recall process and act as middlemen between the manufacturer and the consumers in the process of exchanging or refunding the products. Still, even these companies generally recover less than half of the total number of products released into the stream of commerce.

An attempt has been made in prior systems to distribute product hazard notices over the Internet—either from a website or by email. However, such systems have no way to target specific information to consumers most interested in it, and a user may end up receiving a large number of notices, most of which are not of interest to that user. Furthermore, some users may receive more than one copy of a particular notice from different sources or even from the same source. Such a high ratio of irrelevant to relevant information may cause users to unsubscribe from the service or to miss or ignore relevant notices.

Therefore, there is a need for a system for delivering only relevant product hazard notices to users in a timely and consistent fashion.

### SUMMARY OF THE INVENTION

According to one aspect of the invention, a method is provided for distributing product hazard information to users, the method comprising sorting user preferences for at least one user, receiving product hazard information from at least one product hazard information source, identifying at least one user to receive the product hazard information based on user preferences, and making the product hazard information available to the at least one identified user. According to another aspect of the invention, the method further comprises processing the product hazard information. According to another aspect of the invention, a method is provided wherein processing the product hazard information further comprises verifying the product hazard information. According to another aspect of the invention, a method is provided wherein processing the product hazard information further comprises determining at least one category for the product hazard information, wherein the at least one category is determined based on at least one product identified in the product hazard information. According to another aspect of the invention, a method is provided wherein the at least one user is presented with a personalized access site when the user accesses a system providing product hazard information. According to another aspect of the invention, the method further comprises registering the at least one user to access the system.

According to another aspect of the invention, a method is provided wherein registering the at least one user is performed before allowing the user to access the system. According to another aspect of the invention, the method further comprises requesting authentication information from the at least one user. According to another aspect of the invention, a method is provided wherein requesting authentication information from the at least one user is performed before allowing the user to access the system. According to another aspect of the invention, the method further comprises accepting at least one user input prior to making the product hazard information available to the at least one identified user. According to another aspect of the invention, the method further comprises recording information related to making the product hazard information available to the at least one identified user in a database. According to another aspect of the invention, the method further comprises sending a notice regarding the product hazard information to the identified at least one user. According to another aspect of the invention, a method is provided wherein sending a notice further comprises sending an electronic mail message to the identified user. According to another aspect of the invention, a method is provided wherein the notice comprises a message indicating that one or more notifications relevant to the identified at least one user are available. According to another aspect of the invention, a method is provided wherein providing the product hazard information is performed after the at least one identified user accesses a system providing product hazard information, wherein system access is performed by following the link. According to another aspect of the invention, a method is provided wherein the user preferences further comprise preferences for whether a user should receive notices regarding product hazard information identified for the user.

According to another aspect of the invention, a method is provided wherein the user preferences further comprise at least one of: a time when the notices should be sent out, a portion of a day when the notices should be sent out, an indication of when the notices should be sent out, preferences indicating notices regarding which product hazard information should be sent out. According to another aspect of the invention, a method is provided wherein the user preferences further comprise preferences for categories of product hazard information regarding which notices should be sent out. According to another aspect of the invention, a method is provided wherein the user preferences further comprise an indication of products for which notices regarding available product hazard information should be sent out. According to another aspect of the invention, a method is provided wherein user preferences for a user further comprise an indication of categories for which product hazard information should be presented to the user. According to another aspect of the invention, a method is provided wherein user preferences for a user further comprise an indication of user's geographical location. According to another aspect of the invention, a method is provided wherein user preferences for a user further comprise an indication of at least one geographical area of interest to the user, wherein product hazard information for products relevant to the at least one geographical area should be made available to the user. According to another aspect of the invention, the method further comprises an indication of product categories for which product hazard information should be made available to the user. According to another aspect of the invention, a method is provided wherein user preferences further comprise an indication of granularity for the at least one geographical area. According to another aspect of the invention, the method further comprises determining at least one logged-in user from the at least one identified user, and presenting the product hazard information to the at least one logged-in user from the at least one identified user. According to another aspect of the invention, the method further comprises recording information related to presenting the product hazard information to the at least one logged-in user from the at least one identified user in a database. According to another aspect of the invention, the method further comprises sending a notice regarding the product hazard information to the identified at least one user if the at least one user has not previously accessed the product hazard information. According to another aspect of the invention, the method further comprises recording information related to sending the notice to the at least one identified user in a database. According to another aspect of the invention, a method is provided wherein the information related to presenting the product hazard information is stored in the database in memory.

According to another aspect of the invention, the method further comprises preserving the database for at least a pre-set amount of time. According to another aspect of the invention, a method is provided wherein each user from the at least one user has a unique identifier. According to another aspect of the invention, the method further comprises recording, for a user accessing the product hazard information, user's unique identifier in the database. According to another aspect of the invention, the method further comprises making at least a portion of information stored in the database available to a third party in response to a subpoena. According to another aspect of the invention, a method is provided wherein the at least a portion of information stored in the database comprises identification information that identifies a user who accessed the product hazard information and a date and time of the access. According to another aspect of the invention, a method is provided wherein the product hazard information has a unique identifier. According to another aspect of the invention, a method is provided wherein the information related to presenting the product hazard information further comprises at least one of: a time of the presentation, a data of the presentation, a unique identifier of a user to whom the product hazard information was presented, and the unique identifier for the product hazard information. According to another aspect of the invention, the method further comprises modifying user preferences for a first user by the first user, and storing information regarding modification of the user preferences for the first user in a database. According to another aspect of the invention, the method further comprises receiving product warning information from a second user. According to another aspect of the invention, a method is provided wherein the product warning information is a report from the second user of potential problems related to a product. According to another aspect of the invention, the method further comprises verifying the product warning information.

According to another aspect of the invention, a method is provided for identifying at least one third user to receive the product warning information based on user preferences, and making the product warning information available to the identified at least one third user. According to another aspect of the invention, a method is provided wherein making the product hazard information available to the identified at least one user comprises making the product hazard information available through at least one of a group including of: a website, a telephone, an electronic mail message, an instant message, and a television. According to another aspect of the invention, a method is provided wherein making the product hazard information available further comprises making the product hazard information available simultaneously through two or more of the group. According to another aspect of the invention, a method is provided wherein information regarding access to the product hazard information is recorded in a database, and wherein the information regarding access to the product hazard information further comprises an indication of a method of access. According to another aspect of the invention, the method further comprises authenticating the at least one identified user. According to another aspect of the invention, a method is provided wherein the authentication is based on a username-password combination. According to another aspect of the invention, the method further comprises registering the at least one user, and creating a set of preferences for the at least one user.

According to one aspect of the invention, a method is provided for administering a survey, the survey having a plurality of questions, the method comprises presenting, to at least one user, a single question of the survey, the single question soliciting an opinion of the user, and having at least one of a positive or negative response. According to one aspect of the invention, the method further comprises maintaining a response distribution associated with the single question. According to one aspect of the invention, the method further comprises presenting to the user, at least one other question, the at least one other question verifying the response distribution of the single question. According to another aspect of the invention, a method is provided wherein the at least one other question is a rephrasing of the single question wherein the at least one other question produces a response similar to a response to the single question. According to another aspect of the invention, a method is provided wherein the at least one of a positive or negative responses are yes or no, respectively. According to another aspect of the invention, the method further comprises including the single question in an electronic mail message sent to the user. According to another aspect of the invention, the method further comprises displaying the single question to the user in a user interface. According to another aspect of the invention, a method is provided wherein the user interface is a browser program that displays a markup language document including the single question. According to another aspect of the invention, the method further comprises maintaining a list of one or more questions of the plurality of questions of the survey to which the user responded, the list being associated with a user ID associated with the user. According to another aspect of the invention, the method further comprises maintaining a list of one or more questions of the plurality of questions of the survey to which the user has not responded, the list being associated with a user ID associated with the user. According to one aspect of the invention, the method further comprises presenting to the user, at least one other question, the at least one other question being on the list of one or more questions to which the user has not responded.

### BRIEF DESCRIPTION OF THE DRAWINGS

In the drawings:

FIG. 1 is a schematic representation of a system according to one embodiment of the invention;

FIG. 2 is a flow chart for processing a product hazard notice according to one embodiment of the invention;

FIG. 3 is an illustration of a sample of product categories according to one embodiment of the invention;

FIG. 4 is a flow chart for a method of presenting an interface to a user according to one embodiment of the invention;

FIG. 5 is an illustration of a user interface according to one embodiment of the invention;

FIG. 6 is a schematic representation of a hierarchy of user preferences according to one embodiment of the invention;

FIG. 7 is an illustration of a user interface that allows a user to change their preferences according to one embodiment of the invention;

FIG. 8 is a flow chart showing a process of new user registration according to one embodiment of the invention;

FIG. 9 is an illustration of a user interface for authenticating users according to one embodiment of the invention;

FIG. 10 is an illustration of a user interface for registering a new user according to one embodiment of the invention;

FIG. 11 is a schematic representation of a hierarchy of additional functions presented to a user in the user interface according to one embodiment of the invention;

FIG. 12 is a flow chart showing a process of providing a user survey to users; and

FIG. 13 is a flow chart showing a process for providing a link to a fulfillment company site.

### DETAILED DESCRIPTION

One aspect of the invention relates to a system for providing product hazard information to users in a timely and reliable fashion. Manufacturers may be interested in consumers receiving hazard information the notices in a timely fashion for many reasons. For example, if the recall proceeds as planned and a significant number of consumers are notified, a manufacturer may avoid liability for injuries as more consumers that use the products are notified before injuries occur. Moreover, the manufacturer would like to know who received the hazard notice in order to defend itself in frivolous lawsuits where a consumer continues to use the product despite the notification or even stages an accident after reading the product hazard notice.

Manufacturers may also like to receive statistics information about consumers who receive their product hazard notices. They may be interested in such information as the total number of consumers who receive a particular notice, sociological information about people who receive the notice, what kind of information in which they are most interested, in what form they would prefer to receive the information, and other information. By analyzing statistical information about consumers who receive the product hazard notices, a manufacturer may be able to get a better understanding of its consumers and their interests, and how its products are being used, therefore gaining information that may be used in new product design.

Likewise, fulfillment companies may want consumers to receive the product hazard notice information because the processing of receive information generates revenue for them. Further, fulfillment companies may prefer to have a way to connect to the consumers who receive the product hazard notice, so that a consumer receiving such a notice does not have to research additional information and may instead easily contact the fulfillment company. And, just like the manufacturers, fulfillment companies may be interested in statistical information that relates to the consumers that receive the product hazard notices.

Still, manufacturers and fulfillment companies may not be the only ones interested in the statistical information. A number of other entities and third parties such as government agencies and consumer boards may be interested in receiving information about product recalls and their fulfillment. Such information may be needed, for example, by the Government to include in a report, to determine a niche for a particular type of companies within the economy, or to access the overall dangerousness of a particular type of product. In addition to receiving product hazard notices, users sometimes may want to share their own stories about defects in particular products that they have purchased or accidents that may have happened because of a defective or a substandard product or part. Such stories, if verified, may serve as a warning for other consumers or may later become sources for new product hazard warnings. Furthermore, users may like to receive recommendations for particular agencies, boards, companies, or manufacturers to contact with that information.

A system according to one embodiment of the invention may provide a user with product hazard information for products in which that particular user is interested. Furthermore, the system may keep track of access information including the product hazard notices that have been provided to each user, as well as information about what user received a particular notice and when they received it. This information may be kept for a long period of time, and may be made available in case of a future litigation or other court action compelling disclosure. In addition to providing product hazard information to the consumers, such a system may provide users with fulfillment information about products for which recall notices have been issued, or, possibly, even to provide links directly to appropriate fulfillment companies' web pages.

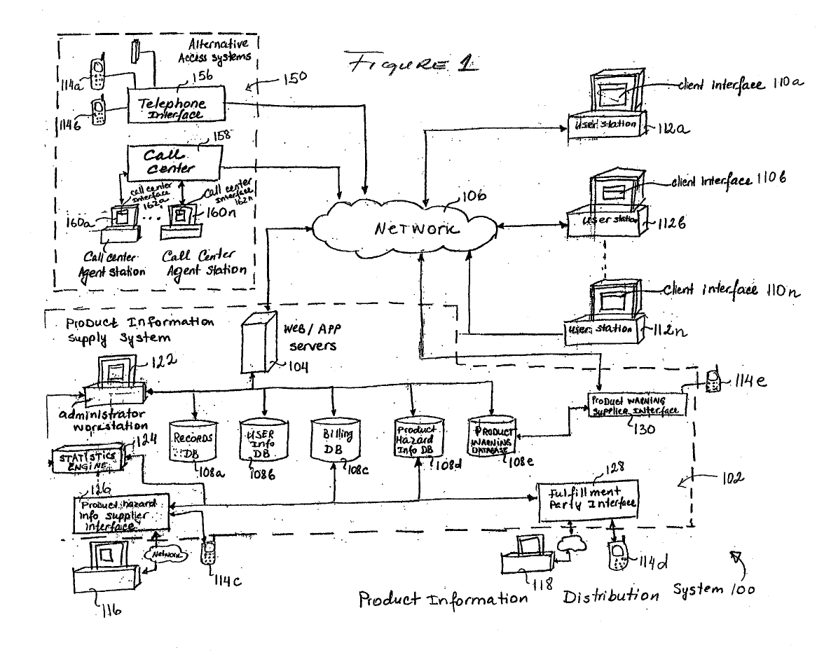

FIG. 1 shows a schematic representation of a product information distribution system 100 according to one embodiment of the invention. System 100 may distribute product hazard information to users, as well as other information associated with the stream of commerce and user functions in general.

A user may be an individual, a family unit, a group of individuals, a company, a fiduciary entity, or any combination of the above. An entity, likewise, may be an individual, a company, a fiduciary entity, a government entity, or any combination of the above. According to one embodiment of the invention, system 100 does not impose restrictions on who may register for service provided by system 100. In an alternative embodiment of the invention, use of system 100 may be limited to a particular group of individuals, financial entities, or a combination of the above. In yet another embodiment of the invention, a user may be a different type of entity, as appropriate for a particular application, as determined by one skilled in the art. Each user of system 100 may be assigned a unique identifier, by which that user may be identified. The unique identifier may be based on a user name, an internal system calculation, a constant, or any combination of the above.

The term “product” as used herein may refer to any good, consumer or otherwise, that may be generally placed in the stream of commerce. The term “product hazard information” refers to any information regarding usability or functionality of a product; it is not limited to official “recall notices” issued by manufacturers. For example, product hazard information for a particular model of a car may include information about certain defects of the car that are result of a production oversight, defects that occur after prolonged use, information about uses of the car that are not recommended, such as, for example “driving the car at high speeds in wet or snowy condition,” information about possible additions or uses of the car that improve usability and/or safety, additional features of the car, etc. In an alternative embodiment of the invention, product hazard information may also include general notices or press releases provided by the manufacturers or other entities. In yet another embodiment of the invention, product hazard information may also comprise advertisements or opinion information supplied by manufacturers, specialists, users, or other entities.

Product hazard information provided to users may be received from manufacturers of products, according to one embodiment of the invention. A term “manufacturer” is used herein to refer to any entity or individual participating in the stream of commerce. A manufacturer may be, for example, an entity producing goods, distributing goods to other goods distributors, distributing goods to consumers, acting as an agent for another entity, generally being related to the consumer process, or any combination of the above. In another embodiment of the invention, a manufacturer may also be a provider of services, goods, or combination thereof.

In an alternative embodiment of the invention, product hazard information may be received from entities other than manufacturers, such as, for example, product distributors or other distributors of product hazard information. In yet another embodiment of the invention, at least a portion of the product hazard information may be generated, either automatically or by personnel, as a part of system 100 functionality if, for example, system 100 is created and maintained by one or more manufacturers. In yet another embodiment of the invention, at least a portion of the product hazard information may be received from entities acting as distributors of the product hazard information.

System 100 may be implemented by a client-server architecture, where servers 104 and associated databases 108a-108e, as well as other elements, generally form a server side 102. Clients 112a-112n allow users to access the system and may be generally referred to as the client side. Communication between server side 102 and clients 112a-112n may be accomplished through network 106. Network 106 may be any medium that facilitates between two or more computers, such as, for example, a global network—the Internet, a local area network (LAN), direct connection lines such as fiber optic or copper cabling, a wireless medium or network, or any combination of the above.

According to one embodiment of the invention, separation between the server side 102 and the clients may be functional and not necessarily physical. Any number of the client computers 110a-110n may be located physically near or may be same physical machines as servers 104 or computers housing databases 108a-e.

Servers 104 may generally comprise one or more hardware or software modules capable of providing—“serving”—information to clients. Server 104 may be, for example, several computers connected by a network, such as, for example, network 106. Each server machine may be, for example, a single or multi-processor computer, configured to access one or more databases or storage area and to serve information as appropriate to the clients. An alternative embodiment of the invention may include one or more other server functionalities, as deemed appropriate by one skilled in the art. For example, servers 104 may serve web pages (that is, perform as HyperText Transfer Protocol (HTTP) servers) or may serve other applications or store application data.

Databases 108a-e may be implemented, for example, as a database housed on a computer, filing system where files act as units of information, logical partition on a storage device, a file or multiple files, a software object, an agent, a data structure, or any combination of the above. Databases 108a-e may be separate databases or logical partitioning of one or more databases.

Records database 108a may include records that indicate a user's access to one or more portions of product hazard information. It may store, for example, such information as a time and date of each access, an identity or a unique identification number of the user who made a particular access, which information was accessed, etc. In one embodiment of the invention, records in database 108a do not include personal user information. Rather, the records refer to individuals by unique identifiers. In an alternative embodiment of the invention, personal user information may be stored with records of the records database 108 and may be stored in an encrypted, or unencrypted form. Records of database 108a may be implemented as records of the database, objects, data structures, or any other form.

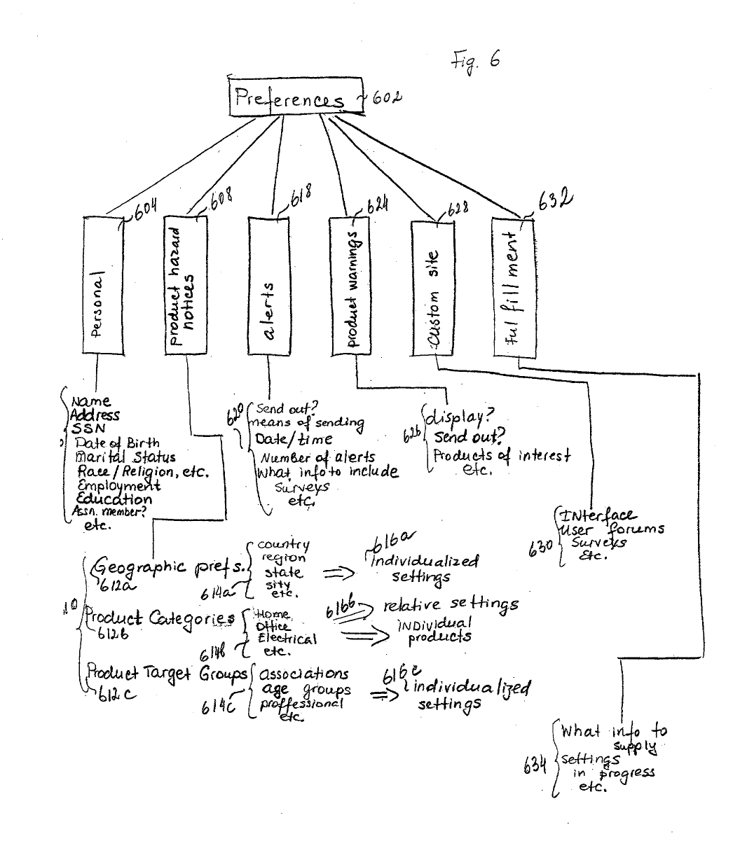

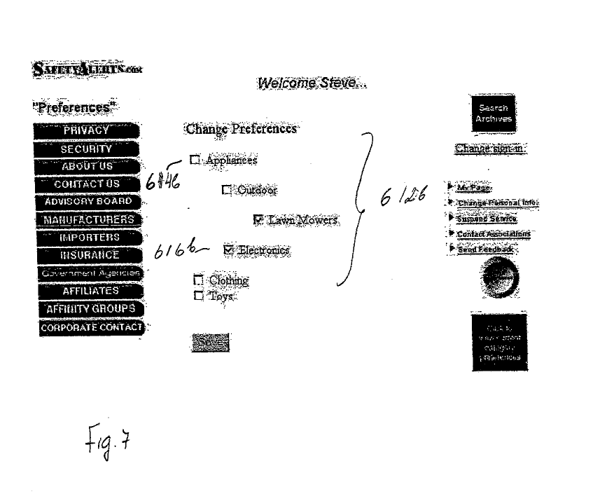

User information database 108b may store information that relates to users of the system. For instance, a separate record may be stored for each indicating user preferences in using the system and user personal information, such as name, address, telephone number, etc. User preferences and personal information will be described in more detail below in connection with FIGS. 6 and 7. In addition, user information database 108b may store chronological information about user preferences and personal information—that is, information about all or a portion of the changes to the preferences or personal information and data about when and by whom, and, possibly, in response to what, such changes were implemented. In an alternative embodiment of the invention, user information database 108b may store additional information, as appropriate for the particular embodiment of the invention and as determined by one skilled in the art.

Billing database 108c may store information regarding financial functionality of the system—such as, for example, records about payments, whether from users or from manufacturers, calculations of pricing structures, etc. Some possible pricing structure and associated billing methods are described in a related application entitled “METHOD FOR PERFORMING RISK-BASED PRICING OF A SERVICE OR GOOD” by William A. Knegendorf et al., filed Mar. 18, 2002, the contents of which are incorporated herein by reference.

Information provided to manufacturers, users, and other entities may include, for example, statistics about system use and access. Such statistics may be calculated, for example, by statistics engine 124. Statistics engine 124 may be a hardware or software module, where a module is generally defined as a software program, an agent, a software object, a procedure, a group of instructions, or any combination of the above, or, as appropriate, a computer processor or processors executing any of the above. In one possible embodiment of the invention, statistics engine 124 may be, for example, a statistical package housed on one of server machines 104. Statistics calculated may include total number of accesses to a particular product hazard notice, distribution of users accessing the notice by time, time of access, or user characteristics—such as the user's age or geographical location. In an alternative embodiment of the invention, statistics may also include such information as a number of repeat views of the information, etc. Other statistical information may be provided upon request from an entity or the system administrator, as deemed appropriate by one skilled in the art.

Product hazard information database 108d may contain, for example, product hazard notices available in system 100. In an alternative embodiment of the invention, database load may also contain product hazard notices that are no longer active but were once available in system 100. In yet another embodiment of the invention, product hazard information database 108d may further contain product hazard notices that are not active, yet, but might become active at some point in the future. Each product hazard notice may be assigned a separate unique identification number and may be accessed by its number. Other methods for accessing the database, such as by searching it by name and/or features of the products or manufacturers involved, may be provided.

Product warnings database 108e may contain stories and eyewitness accounts submitted by users. Such stories may include, for example, stories regarding accidents that involve one or more products. Product warnings database 108e may also contain information associated with reporting those user warnings to appropriate entities, such as, for example, manufacturers or government agencies. In an alternative embodiment of the invention, product warnings database 108e may contain further information related to product user warnings, such as resolution of a particular warning or product hazard notices that were issued for the products involved.

Databases used by system 100 are not limited to the ones described above. Other databases storing other information as appropriate may be included in system 100 and the invention is not limited to the implementation or particular contents of the databases is described above.

Operation of databases 108a-e and servers 104 may be supervised and/or modified by system administrators. Such system administrator or administrators may use, for example, administrator workstation 122. Administrator workstation 122 does not need to be physically located near servers and databases that it is administrating. Administrator workstation 122 may be generally any computer, from which an administrator may access workings of system 100. Administrator workstation 122 may contain administrator software (not shown) used to access all or certain portions of system 100, and this administrator software may be executed on any system for the purpose of performing administrative functions. Any number of administrators and administrator workstations may be provided in the system, as deemed appropriate by one skilled in the art.

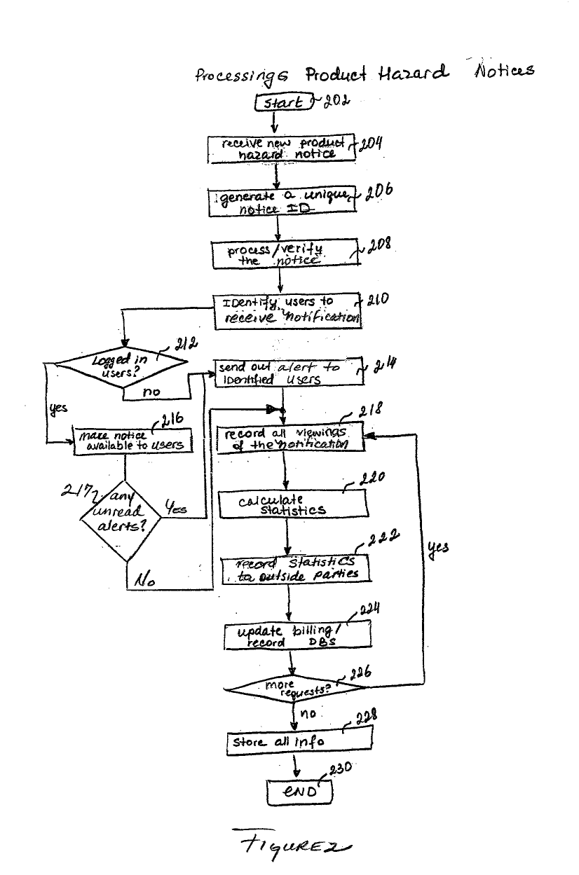

Server side 102 may further include access points for entities such as manufacturers, fulfillment companies, and users. For example, server side 102 may contain product hazard information supplier interface 126, through which product hazard information may be submitted by manufacturers, users, etc. Product hazard supplier interface 126 may be a hardware or a software module designed to accept and process product hazard information. In an alternative embodiment of the invention, product hazard supplier interface 126 may further include system personnel. Product hazard information suppliers may access interface 126 through computer 116 or telephone 114c. Operation of the product hazard supplier interface 126 and product hazard information processing is further discussed below in connection with FIG. 2.

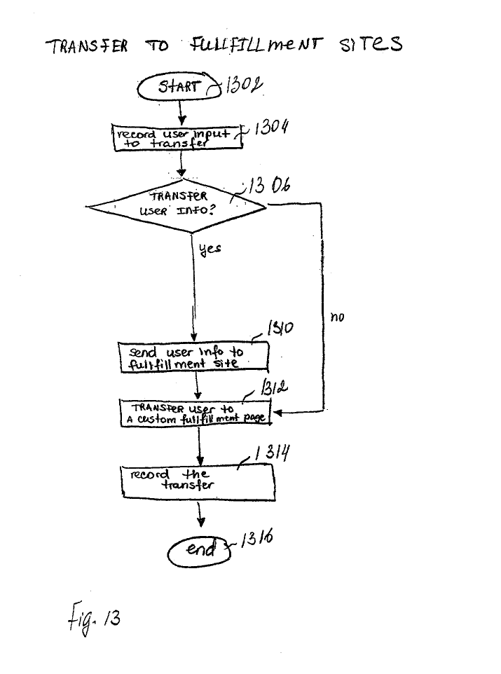

Server side 102 may also include a fulfillment party interface 128. Interface 128 may be used by fulfillment companies to register as fulfillment entities for a particular product. In an alternative embodiment of the invention, interface 128 may be used to link product hazard notices to fulfillment companies or to provide information to fulfillment companies about users accessing product hazard notices. Representatives of fulfillment entities may contact system 100 by using workstations 118 or by telephone means 114d. Fulfillment interface 128 is described in further detail in connection with FIG. 13.

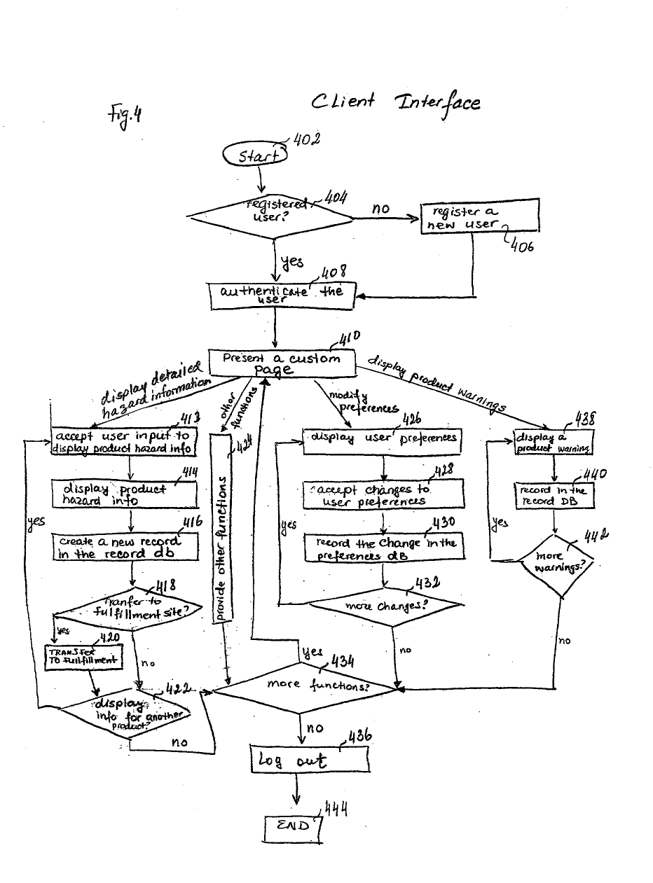

Users may access system 100 by using user stations 112a-n running user client interface 110a-n. Client interface may be an application or web pages configured to display information provided by system 100. Client interface 110 may be configured by individual users to suit their needs and to represent information according to the preference of each user. In an alternative embodiment of the invention, a number of different client interfaces may be provided by system 100. In yet another embodiment of the invention, client interfaces may be especially adapted to particular user's needs. Such as, for example, client user interface 112b may be adapted to present only text in order to facilitate access to a user who is blind and is using text-to-speech interfaces to access system 100. Client interfaces and their modification are further discussed in connection with FIGS. 4 through 13.

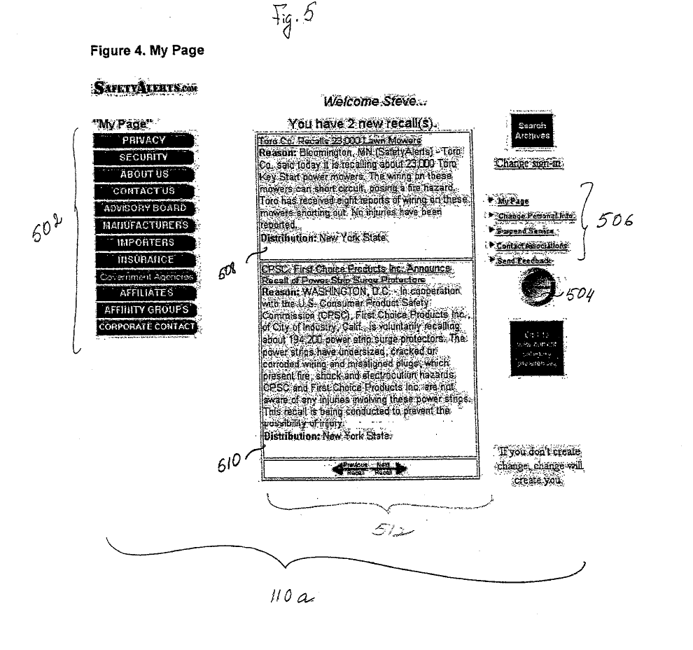

In addition to receiving product hazard information through client interfaces 110, users may receive additional product hazard notices or alerts using other methods. For example, system 100 may send out product hazard alerts when new product hazard alerts are available to a particular user. Such product hazard alerts may be sent out, for example, by electronic mail (not shown) or may be picked up by users at their convenience. Product hazard alerts will be further described below in connection with FIG. 5.

Users may use methods other than accessing system 100 using workstations to obtain product hazard information. Such means may include, for example, a telephone. Alternative means 150 is provided in system 100. Alternative access may be generally a part of server side 102. In an alternative embodiment of the invention, alternative access may be not a part of server side 102 and may act as clients to server side 102, while acting as servers or providers of information to users.

Alternative access 150 may be comprised of entities outside of system 100 supplying access to system 100. Such alternative access may include, for example, telephones. Users may use telephones 114a-n to access telephone interface 150. Telephone interface 150 may provide substantially the same functionality, except relayed through a telephone, as client interfaces 110a-n. Such functionality may include a voice interface or telephone Internet access interface. A voice interface presents information in an audio format, while telephone Internet access interface may include a telephone web browser, such as, for example, a WAP-capable browser. Telephone interface 156 may be connected to server side 102 through network 106.

Telephone interface 156 may be implemented, for example, as a computer or software module adapted to receive telephone connections and perform functions based on user input supplied through a telephone—such as, for example, by voice or by pressing telephone buttons.

In an alternative embodiment of the invention, telephone access may also include a call center 158. Call center agents (not shown) may access call center 158 through call center interfaces 162a-n located on call center agent stations 160a-n. Users may access call center 158 and speak to one or multiple call center agents to access system 100. Call center agents may represent sufficiently same functionality as client interfaces 110a-n. In an alternative embodiment of the invention, call center agent interface 162a-n may be similar or identical to client interfaces 110a-n, and may provide the same functionality.

In general, alternative access 150 are not limited to what is described above, and may include any of other alternative, as deemed appropriate by one skilled in the art. Such alternative access may include, for example, television access, post mail access, electronic mail access, or in-person access.

System 100 is not limited to the embodiment of the invention described above and may be modified by one skilled in the art, as appropriate. In an alternative embodiment of the invention, system 100 may comprise architecture other than a server-client architecture, or modified server-client architecture. In another embodiment of the invention, system 100 may comprise elements other than what is described above, or may be supplemented by additional elements or functions.

Product hazard information supply and processing will now be described in connection with FIG. 2. Product hazard information processing begins at step 202, where product hazard information supplier contacts system 100 to provide a new notice or modify an existing notice.

Product hazard information is received in step 204. Product hazard information may be received automatically by a computerized product hazard information supplier interface 126, or it may be received by personnel acting as part of product hazard information supplier interface 126.

Each separate product hazard notice is assigned a unique ID in step 206. If the manufacturer is modifying information already providing in a previous notice, that notice may be identified by its ID. According to one embodiment of the invention, all such changes to the notices are recorded in the system, thus creating a chronological record of changes. A unique ID may be generated, for example, as the next unused ID in the system. In an alternative embodiment of the invention, the unique ID may be generated by performing some permutation on a representation of the manufacturer information or the product hazard notice.

In yet another embodiment of the invention, a unique ID may be generated, for example, by computing a cryptographic hash of the information hazard notice. The cryptographic hash may serve a dual purpose of serving as a unique ID and acting as an additional time stamp. For example, if at time t0, such a hash is assigned to the notice, and time t1, an authenticity of the notice is challenged, a computation of the cryptographic hash may be performed on the text of the notice at time t1. If the resulting hash is identical to the hash received at time t0, then it can be said with substantial certainty that the text of the product hazard notice was identical at times t0 and t1.

In yet another embodiment of the invention, product hazard unique ID may be selected in such a manner as to facilitate future searches in product hazard information database 108d. Other methods of generating a unique ID may be used, and the invention is not limited to any particular implementation. Furthermore, it is contemplated that one skilled in the art may deem it necessary to assign the same ID to multiple notices, or to reuse the IDs after a particular period of time.

The product hazard notice is processed in step 208, and may include, for example, verifying the notice by authenticating the notice. Such authentication may be performed by a software module or by personnel, and authentication of information is well-known in the art as a method for determining that the information came from a particular source. In addition to authenticating of the notice, product hazard information supplier interface 126 may also verify the information contained in the product hazard notice. Such verification may be accomplished by, for example, receiving corroborating information from other sources. A notice, once verified, is reformatted, if necessary, and a hazard notification is produced and stored at server 100.

Product hazard notice processing in step 208 may further comprise determining one or more categories for products addressed in the hazard notice. For example, a product hazard notice regarding a lawn mover engine may be categorized under “Appliances”, and further subcategorized as “Outdoor appliances” and “Lawn mowers.” These categorizations may be later used in determining which users should receive the product hazard notice.

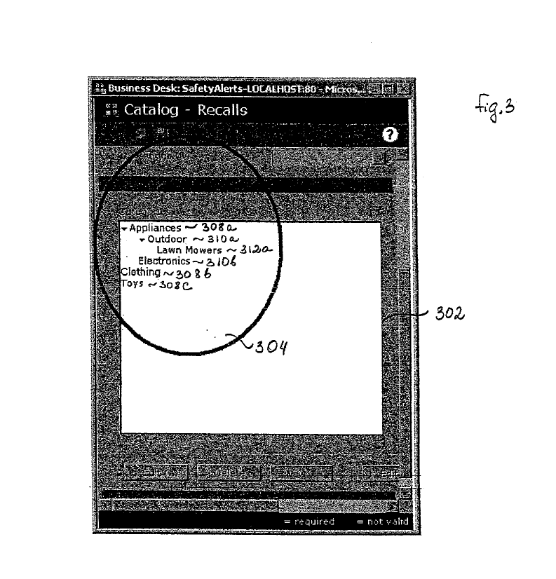

FIG. 3 shows a sample according to product categories of one embodiment of the invention. Product categories may be divided into subcategories, which, in turn may be divided into more specific subcategories or may contain individual products. For example, category 308—“Appliances”—may be subdivided into categories 310a and 310b—“Outdoor” and “Electronics”, respectively. One or more of those categories may be further subdivided, such as, for example, “Outdoor” may be subdivided into “Lawn mowers”—category 312.

A system administrator may impose a category structure and may modify it as appropriate. In an alternative embodiment of the invention, the category structure may be generated automatically or may be suggested by product hazard information suppliers. In yet another embodiment of the invention, the category structure may be that which is commonly used in a particular industry.

User interface 302 may be used by one or more administrators to assign product hazard notices to particular categories. It should be appreciated that the interface used may be different from that which is illustrated in FIG. 3, and the invention is not limited to any particular implementation.

In addition to verifying and categorizing hazard notices, product hazard notices may go through additional textual processing, where, for example, each notice is put into an appropriate textual document. For example, notices may be converted to a single format, such as the HyperText Mark-up Language (HTML) format, or any other format. After processing product hazard notices, they may be stored in product hazard information database 108d, and indexed by unique ID, by category, or by other identifiers, such as, for example, title and/or manufacturer.

Once the product hazard notification is stored in system 100, system 100 may determine users which should be alerted of the new product hazard notification. Users are identified on the basis of user preferences. For example, if a user indicated that he/she would like to receive product hazard information related to the category “Outdoor Appliances,” such a user would be identified to receive a notification regarding a particular model of a lawnmover. User preferences are discussed in further detail below in connection with FIG. 6.

A check is performed in step 212 to identify those users who are currently logged in. If there are logged in users, they are immediately notified about the new notification in step 216. This notification may take form of, for example, an alert presented to the user in a client interface. In an alternative embodiment of the invention, notification may be provided to logged-in users only if their preferences indicate that they would prefer to receive such notification during their access to system 100. At block 217, if there are any alerts that have not been received by the user (e.g. alerts that have not been read and a receipt generated), the system may send out an alert to the user indicating that there are unread alerts available.

Users who are not logged into the system when the new or modified notification arrives may be notified through other means, such as, for example, electronic mail. Notification is performed to the user (whether or not they are logged in) in step 214 for any alerts. Users may set their preferences for receiving electronic mail alerts—when to receive them, and where they should be sent. In a first embodiment of the invention, electronic mail alerts only comprise a notification that one or more new notices are available for user to view. This sparse notification is beneficial, as it forces the user to log in to the system to retrieve any notifications. Therefore, as the user logs in and retrieves the notifications, access to each notification may be recorded. In a second embodiment of the invention, each electronic mail message may contain links to a user's client interface. By clicking on those links or typing them into web browsers, users may be able to access product hazard information contained in alerts. In a third embodiment of the invention, electronic mail alerts may include titles of new product hazard notification. In a fourth embodiment of the invention, electronic mail alerts may include full or partial information from the product hazard notification.

Once users have been notified of the new or modified product hazard notification, they may “pick up” those notices, by accessing the system and requesting the product hazard information. In the first embodiment of the invention of the invention, users may be prompted for user input before system 100 provides each product hazard notice to them for viewing. For example, they may be required to click on a particular portion of user interface 100a to receive a product hazard notice after they viewed one product hazard notice. In the second embodiment of the invention, such additional input may not be needed and all product hazard information may be provided at once. User interface is described in more detail in connection with FIG. 4.

According to one embodiment of the invention, data associated with each presentation of each product hazard notice may be recorded in records database 108a in step 218. Such data may include day and time of the viewing, and other associated information.

Statistics engine 124 may calculate access statistics, such as distribution of users accessing the notice, common features among users interested in a particular product hazard notice, etc. Any other statistical measurement may be performed. In another embodiment of the invention, statistics engine 124 may determine, for example, a correlation between two or more notices—that is, a percentage of users that access two or more notices in the same system session. For example, statistics engine 124 may determine that there is a strong correlation between users reading product hazard notices about car seats and about cars. Conversely, engine 124 may determine that there is an insignificant correlation between users reading product hazard notices about oil and gas heaters.

Statistics may be recorded in step 222. In an alternative embodiment of the invention, they may be provided to outside entities such as, for example, manufacturers, fulfillment companies, government agencies, insurance companies, etc. There may be associated billing records for statistics supplied to outside entities. Such records are updated in step 224. If there are additional requests for information, as determined in step 226, the system may proceed to record additional information in step 218. If no other requests have arrived, information associated with a particular product hazard notice may be stored in product hazard information database 108d, and processing terminates in step 230.

While one example of product hazard notice processing has been outlined in the flow chart of FIG. 2, not all steps need be executed in the order shown. According to an alternative embodiment of the invention, two or more steps, such as, for example, steps 218 through 226, may be performed simultaneously. In yet another embodiment of the invention, those steps may be performed continuously for a predetermined duration.

According to one embodiment of the invention, each product hazard notice may remain on the system and active for a prolonged period of time, such as, for example, several years. In an alternative embodiment of the invention, a manufacturer may set an expiration date for each product hazard notice on a case by case basis. In a third embodiment of the invention, product hazard notices that have not been accessed for a long periods of time may be deactivated, although they still may be stored in the product hazard information database 108d.

Product hazard notice processing is not limited to any particular implementation described above and may be modified as appropriate for a particular application.

FIG. 4 shows a flow chart outlining operation of client user interface 110. Access to the client interface 110 starts in step 402, where a user may load or install client interface 110. In the first embodiment of the invention, client interface 110 may be a web page, and loading client interface 110 may involve accessing a particular web page using a web browser. In an alternative embodiment of the invention, client interface 110 may be a stand-alone program having a different access method. Alternatively, users may access the system through alternative access systems 150, in which case, initiating the client interface may involve, for example, calling a particular phone number.

In the first embodiment of the invention, the users may perceive the same functionality regardless of access method—that is, options available to them are similar or identical in all alternative access methods and in the main client interface. In an alternative embodiment of the invention, functionality available through alternative methods of access may be a modified version of the main functionality. In yet another embodiment of the invention, different functionality may be offered through different methods of access.

According to another embodiment of the invention, only registered users may access product hazard information. A check is performed in step 404 to determine whether a particular user has been registered. If the user has not registered, he/she is given an option to register as a new user in step 406. A registered user may be authenticated in step 408. Authentication may be performed, for example, by requesting the user to enter a username and password combination. A username is initially assigned during the registration process, as is further discussed in connection with FIGS. 5 and 6. The password may be assigned or may be chosen by the user.

In an alternative embodiment of the invention, authentication may be performed through any method known in the art, such as, for example, authentication certificates, digital signatures, physical authentication, such as a thumbprint, retina scan, or any combination of the above. Various security schemes may be employed to provide secure transfer of user information. Such schemes may include, for example, Secure Socket Layer (SSL) protocol transfers, symmetric or asymmetric key encryption, one time pad encryption, hardware security and authentication devices, or any combination of the above.

Once the user has been authenticated, a customized page may be presented to the user in step 410. The custom page may be arranged according to the user's preferences and provides user with multiple functionality. An exemplary user page is illustrated in FIG. 5.

The custom page may include, for example, a summary 512 of notifications relevant to the user. Summary 512 may include portions of notifications that summarize the hazard, and allows the user to quickly review notifications. If additional details regarding the notification are required by the user, the user could select a notification in the summary window to display the detailed product hazard information. Access to notifications displayed to the user may be recorded, and the summary window may be manipulated (for example, by a scroller bar) to display additional notification, and record accesses by the user.

Buttons 502 are presented in the custom user page that provide access to system functionality, links 506 that provide access to preferences and personal user settings, button 504 providing quick access to user preferences, and product hazard notices 510 and 508. Client interface 110 is not limited to the representation shown in FIG. 5 and may be implemented in various ways, and the invention is not limited to any particular implementation. Furthermore, appearance of client 110 may vary from user to user, because users may be allowed to modify appearance of their interfaces 110a-n.

In general, client interface 110 may provide different functionality, such as, for example: displaying product hazard information, providing an interface to modify user preferences, displaying product warnings, and providing access to additional system functions.

A process for displaying detailed product hazard information may proceed, for example, from step 413, where client user interface 110 accepts user input indicative of a request to receive more detailed information related a particular product hazard notice. Product hazard information may then be displayed in step 414. Detailed product hazard information may be displayed in the same window as client interface 110, or may be provided in a separate window. In an alternative embodiment of the invention, only a portion of a particular product hazard notice may be displayed, and an additional user input may be needed in order to display additional parts of the product hazard notice.

According to one embodiment of the invention, a new record is created in the record database 108a every time a user is supplied with a product hazard notice. Recorded in the record may be information about date and time of displaying the product hazard notice, a unique identifier of the product hazard notice displayed, a unique identifier of the user viewing the notice, and other information, as appropriate. In an alternative embodiment of the invention, such information may be added to already-existing records, or linked to user personal information or preferences.

According to one embodiment of the invention, records of user viewing product hazard notices are kept for at least a predetermined period of time. There may be links to fulfillment companies provided in the client user interface. Links may include contact information, or may be HTML links to fulfillment websites. Furthermore, a particular link visually located near a particular product hazard notice may link users directly to a website specially addressing fulfillment of the particular product mentioned in the product hazard notice.

If the user prefers to follow on to the fulfillment site, as indicated by a check performed in step 418, the user is transferred to the fulfillment site at step 420. If the user does not wish to be transferred to the fulfillment site, or has returned from the fulfillment site, a check may be made in step 422 to determine whether the user would like to view another product hazard notice. If other product hazard notices are requested, the client interface 110 returns to step 412. If no other product hazard notices are requested, client interface 110 proceeds to step 434, where the user may choose to access other client interface 110 functions.

One of the functions that the user may elect to perform is modifying user preferences. Modification of user preferences may start in step 426, where existing user preferences are displayed to the user. User preferences may be presented in such a manner as to allow the user to review the existing preferences and easily make one or more modifications to them. User preferences are discussed in more detail below in connection with FIGS. 5 and 6. User preferences may be modified in step 428. After the user has finished modifying the preferences, a new set of preferences may be recorded in the user information database 108b. As discussed above, according to one embodiment of the invention, the new set of user preferences may be stored in such a way so as not to over-write a previous set of preferences associated with the particular user, thus creating a chronological log of preference changes for that user.

A check is performed in step 432 to determine if additional changes to preferences are required. If the user wishes to modify more preferences, client interface 110 returns to step 426. Otherwise, client interface may proceed to step 434, where the user may select additional functionality.

One of the available functions may include the function of viewing product warnings. Product warnings may be displayed to the user in step 438. Display of the product warnings may be done according to user preferences—for example, users may indicate which categories of warnings they would like to view.

According to one embodiment of the invention, product warnings may be displayed in such as fashion as to allow users to share their opinion or submit additional stories about the same product. In another embodiment of the invention, product warnings may be accompanied by links to product hazard notices issued in connection with the mentioned product.

Records are created in records database 108 upon displaying product warnings to users. Product warning records may include substantially similar information as records created upon providing product hazard notices to the users. In an alternative embodiment of the invention, product warning records may contain different information, indicative of a particular product. Various statistics may be computed based on the product warnings records.

A check is performed in step 442 to determine if the user wants to view additional product warnings. If more product warnings are requested, the client interface 110 returns to step 438, otherwise it proceeds to step 434, where the user may select additional functionality.

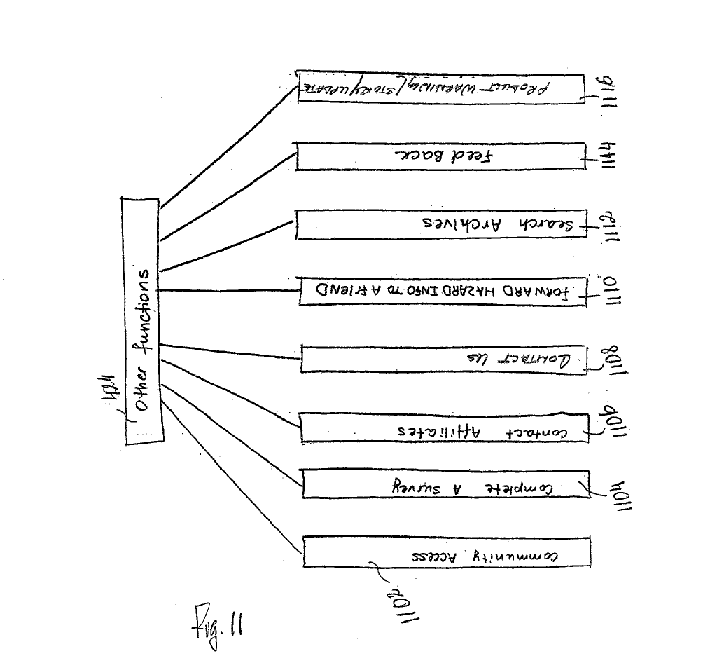

Client interface 110 may provide functionality beyond what is described above. At least a portion of other available functions as provided in step 424 is described below in connection with FIG. 11. Implementation of client interface 110 is not limited to the particular embodiments described above, and it may be implemented in any way deemed appropriate by one skilled in the art, utilizing graphic or textual user interface functionality.

FIG. 6 shows a schematic representation of a hierarchy of user preferences. In one embodiment of the invention, user preferences 602 may be organized based on a hierarchical structure. In an alternative embodiment of the invention, a different organizational structure may be used.

User preferences 602 may be generally subdivided into personal preferences 604, product hazard notices preferences 608, alerts preferences 618, product warnings 624, customized website preferences 620, and fulfillment preferences 632.

User preferences 602 may include, for example, such preferences 606, as a name, address, Social Security Number, date, marital status, employment status, education level, information about memberships in trade or consumer associations, etc. Any of the above information fields may be optional—that is, the user does not need to enter them to register to use system 100. Consumers may elect to provide information above what is required, because system 100 may provide additional functionality based on the additional information. For example, if a user registers himself/herself as being a member of a medical professional organization, the user may later receive information relevant to medicine and product hazard notices of medical products.

Product hazard information preferences 608 may include a number of categories and subcategories of preferences, spanning the breadth of consumer products. In one embodiment of the invention, categories that users may use in their preferences correspond to product information categories. For example, shown in FIG. 7, there is a user interface for selecting product hazard information preferences. Categories 612b in FIG. 7 correspond to those discussed above in connection with product hazard notices categories. In an alternative embodiment of the invention, a different set of categories and subcategories may be uses in user preferences selection. In a third embodiment of the invention, each user may specify categories of products of interest to him/her.

Specificity of categories and product preferences settings may depend on a particular embodiment of the invention. In one embodiment of the invention, only categories of products may be shown. In another embodiment of the invention, user may be able to select specific products. In yet another embodiment of the invention, users may be able to supply additional specificity—such as a particular product, produced in a particular year or in a particular production factory. Preferences may be adjusted as deemed appropriate by one skilled in the art.

In addition, user preferences 608 may comprise geographic preferences 612. Such preferences may define, for example, different granularity of geographic areas of interest to the user. For example, geographic preferences may include a specific city affected by a product hazard notice. In such a way, a person living in Boston may select to not receive any product hazard notices that are not applicable to the Boston area.

User preferences 610 may further include preferences related to one's personal preferences, such as membership in professional organizations, or target age groups. Other categories of preferences may be included for user's modification, as appropriate for a particular embodiment of the invention.

Preferences 602 may further include preferences related to product hazard information alerts that may be sent out to users. Such preferences 602 may include, for example, settings on whether a particular user would like to receive the alerts, of what means of notification should be used, of what general time of day or week the alerts should be sent out in, etc. By allowing the users to select a time at which they would prefer to receive such notifications, one embodiment of the invention is also providing a method of avoiding network congestion, as it is more likely that the alerts will be distributed in time, and will not need to be sent out all at once.

Preferences 602 may further include custom website settings 628. Such settings 628 may include, for example, settings that control appearance of the website that is presented to an individual user upon log in. In addition, settings 628 may control settings about user forums in which a particular user might like to monitor or participate in.

Preferences 602 may further include preferences 632 associated with product recall fulfillment. Such preferences 632 may include, for example, preferences on whether user information should be supplied to fulfillment companies, preferred methods of contacting fulfillment companies, etc. Fulfillment settings are discussed further in connection with FIG. 15.

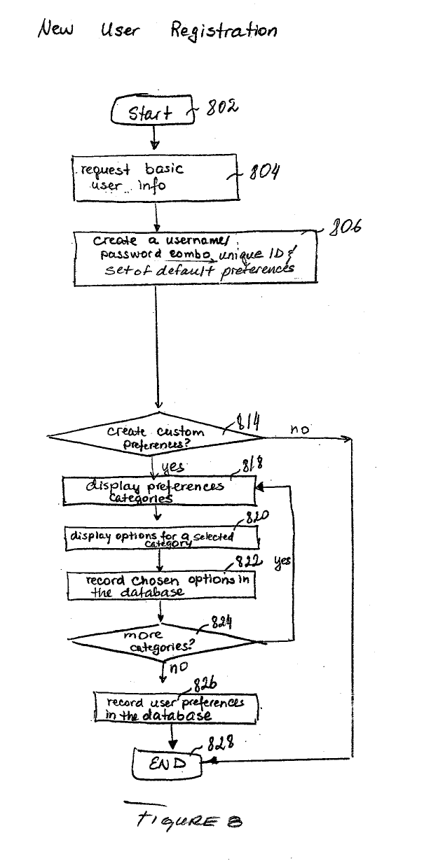

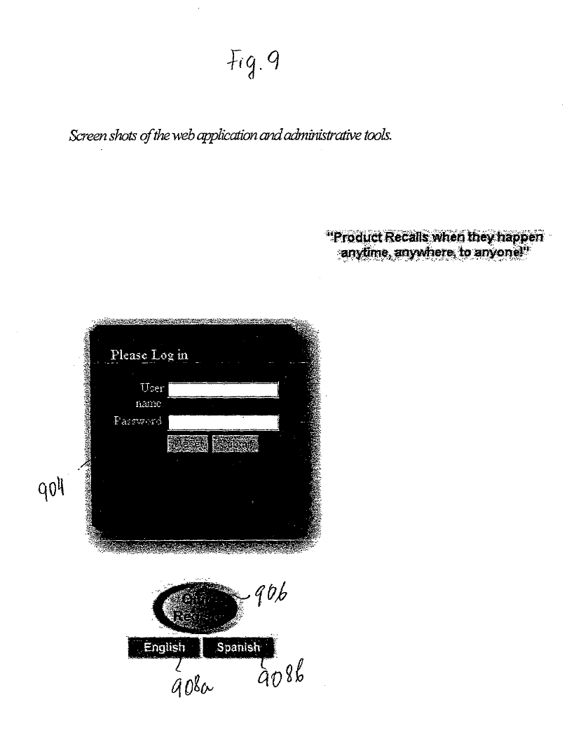

Referring now to FIG. 8, there is shown a flow chart for performing a process of new user registration. New user registration starts in step 802, where a person selects to be registered as a user of the system. The user may select to register for the system by, for example, pressing a “quick register” button, such as link 906 illustrated in FIG. 9. Registration and system access may be provided in any one of numerous languages 908a-n. A language may be selected by pressing an appropriate button. For users of the system, a language of choice may be one of the personal preferences settings. As shown in FIG. 9, registered users may log into the system by using fields 904 to supply a username and password combination.

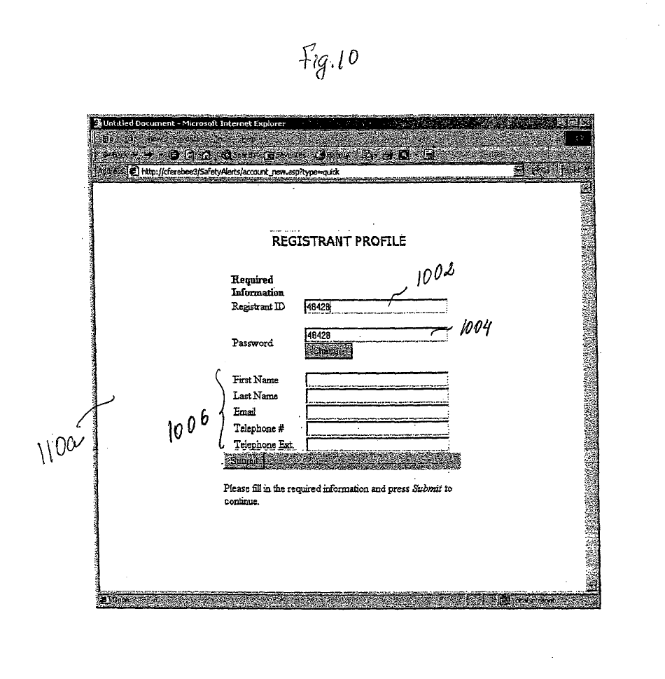

Once the user indicates that he or she would like to register to access the system, an interface is provided in step 804 that requests required user information. Such user information may be, for example: a first name, last name, and an email address. Interface for providing basic information is illustrated in connection with FIG. 10. FIG. 10 shows required fields 1006, including name, e-mail, and telephone information. Other information may be required. Specifics of the required fields and the interface for providing the user information may vary from embodiment to embodiment, as deemed appropriate by one skilled in the art.

In addition, a username and password may be supplied in fields 1002 and 1004, respectively. According to one embodiment of the invention, a username and an initial password may be generated by system 100 in step 806 along with a set of default preferences. In an alternative embodiment of the invention, users may select their own usernames. In yet another embodiment of the invention, a username may be identical to a unique user identification number for that user. This unique user identification number may be, for example, hidden from a user. Also, for each username and password, there may be issued one unique identification number.

Once a username and password is created, the system may generate a default set of preferences in user information database 108b. Users may elect to create custom user preferences, as indicated by a check in step 814. If the user elects to create the custom preferences at the registration time, in step 818, he/she may be presented with a user interface displaying preferences categories. The user may be given an opportunity to select appropriate categories and subcategories of user preferences in step 820, after which selected preferences may be recorded in user information database 108b. User may repeatedly request additional sets of preferences to edit or create. A check is made in step 824 to determine whether additional categories should be presented. If so, the system returns to step 818 where the user may continue to enter additional preferences. Alternatively, the user may elect to skip one or more sections of preferences.

Sets of user preferences may be recorded in user information database 108b, after which the registration process may complete in step 828, and the user may proceed to log into and use the system. If the user does not choose to create custom preferences at step 814, the process completes in step 828. Implementations of the registration process are not limited to what is described herein, and may be modified in any way determined appropriate by one skilled in the art.

A schematic representation of a hierarchy of additional functions available the client user interface 110 is shown in FIG. 11. Such functions may include, for example, community access functions 1102. The term “community access” may be used herein to refer to any forum, chat room, mailing list, instant messaging, or real time system which allows users to discuss information and to share their views on different subjects. In one embodiment of the invention, for example, users may share their opinion using an interface for a user discuss board (not shown). Any other method for allowing users to interact with other system users may be used as part of community access functions 1102.

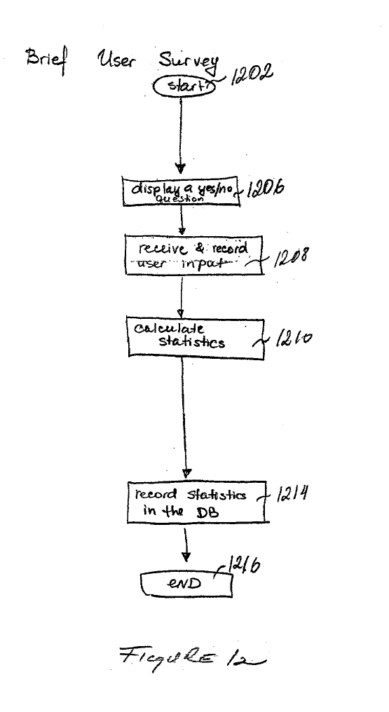

Additional functions 424 may also include completing a brief user survey 1104. Brief surveys may be presented to a number of users in order to gain an understanding of a prevalent user opinion or user suggestions regarding a particular topic, such as changes to system 100, worldwide events, opinions, etc. Brief user surveys are discussed in more detail in connection with FIG. 12.

Other functions 424 may also include a link 1106 to system associates 1106. An associate may be any entity providing product hazard information to system 100, or any other entity featured or mentioned on system 100 web pages. Users may also be allowed to contact representatives of system 100 through the “contact us” function 1108. A web page may be provided, for example, where users may submit their messages to the system representatives. In an alternative embodiment of the invention, a web page containing a list of other contact methods is provided, such as, for example, a list of relevant telephone numbers.

If a user finds a particular product hazard notice or a product warning that he/she believes would be of interest to a friend, he/she they may send information about that notice or warning to the friend, using a forward hazard information to a friend function 1110. In one embodiment of the invention, a link to the product hazard notice may be sent to the friend, and the friend may have to log into the system in order to access the product hazard information. In another embodiment of the invention, the whole notice or portions thereof may be included in the message sent to the friend.

Users may additionally access product hazard notices by searching for them using search interface 1112. Searching may be based, for example, on a title, a particular product involved, manufacturer's name or identification number, product hazard notice identification number, date the product hazard notice was originally posted, relative popularity of the product hazard notice, etc. Other search capabilities may be provided, as appropriate for a particular embodiment of the invention.

In addition to sending general messages to corporate contacts, users may provide feedback on a variety of system functions or changes in feedback function 114. For example, if some aspects of client interface 110 have been changed, special questions to the users may allow them to express their opinion about the changes.

In addition, users may submit product warnings or update their previous warnings using function 1116. Such information may be submitted, for example, using a web form, by telephone, or through other communication methods, such as letters or email. User stories may include accounts of their own experiences with a particular product. For example, a user may submit a product warning if, in the user's ordinary use of the product, the product caused a fire. User stories may be verified before they are posted to the system as product warnings. In another embodiment of the invention, various additional paths of actions may be suggested to the user submitting the story—such as, for example, contacting a manufacturer or a government agency. In yet another embodiment of the invention, representatives of system 100 may contact those entities themselves in order to gain additional information about the reported story or to verify the story.

In one embodiment of the invention, system 100 may monitor possible developments to the product warning and post updates that users may access. For example, if a particular user warning results in an issued product hazard notice, system 100 may link the product hazard notice and the original product warning.

Brief user surveys will now be discussed in connection with FIG. 12. Administration of a brief user survey may begin with step 1202, where a user accesses system 100, or where a message is sent to the user.

The user may need to be authenticated by, for example, logging into the system. Of course, if the user is already logged into the system and viewing the survey, additional authentication is not necessary. User authentication may allow additional statistics to be extracted beyond what is represented in the survey. For example, if the survey involves a “yes” or “no” question about whether users would prefer a change to client interface 110, and the users who took the survey were authenticated, additional information may be extracted, such as, for example: “a higher percentage of older users than younger users may prefer to see a change to client interface 110.”

In an alternative embodiment of the invention, users may be asked to complete the brief user survey without needing to authenticate themselves. In yet another embodiment of the invention, authentication may be optional.

A “yes” or “no” question may be displayed to the user as a part of the brief user survey in step 1206. Such a question may be of the kind that may evoke a strong “yes” or “no” opinion in the user. For example, a question of “what do you think about current events?” would not be an appropriate question for such a survey, as it does not evoke a strong “yes” or “no” response.

Users may select their preferred answers by, for example, clicking on the provided “yes” or “no” buttons. Other means of results submission may be provided, as appropriate for the particular embodiment of the invention. In an alternative embodiment of the invention, users receiving brief surveys over electronic mail may complete the surveys and submit results over electronic mail.

User answers may be received and recorded in step 1208, and various statistics may be calculated in step 1210. Statistics may include, for example, a total distribution of “yes” and “no” votes, or a total percentage of users who completed the survey from those who were presented with the survey.

Conciseness of the survey may increase participation, as users are generally prone to avoid long surveys filled with questions that generally do not evoke a strong response. In comparison, completing a brief survey may be fun, and users may be interested in other users' opinions on the subject.

A portion of the computed statistics may be displayed to the users or may be related generally to users by an information page or e-mail. For example, a total number of users who answered “yes” may be displayed, a percentage of people who answered “no” may be shown, or information may only be related in a general way to the users, e.g. “I was surprised to see the number of people that desire to be notified via pager.”, etc. Additional portions of statistics may be shown.

All survey statistics may be recorded in the database in step 1214. In one embodiment of the invention, it has been empirically shown that 80% of the answers to the survey arrive within a day or two of the survey being posted, while other responses may continue to arrive for a long period of time. In yet another embodiment of the invention it has also been empirically shown that in a large number of cases the total distribution of user answers may be predicted based on the results submitted within a first few hours after the survey has been posted. This empirical observation may allow system administrators to provide accurate statistics soon after the survey has been posted.

The brief survey process completes in step 1216, although it is possible that a particular user will be asked to complete another survey within his/hers continuous interaction with the system. In an alternative embodiment of the invention, a user may request to complete a brief survey based on a particular topic. In yet another embodiment of the invention, the user may request to complete another survey, but the survey provided may be chosen randomly from those available.

In one embodiment of the system, a list of surveys may be kept in the system for one or more users. Surveys provided to a user may be taken from a list for that user. The system may keep track of which surveys have already been seen by the user.

A flow chart for a process of linking to a fulfillment company site is shown in FIG. 12. Such process starts in step 1302, after a user has indicated that he/she would like to access fulfillment company's website in connection with a particular product recall notice.

User input requesting the transfer may be recorded in step 1304. The user may elect his personal information to be transferred to the fulfillment site. Such transfer has an advantage that the user may be spared of having to type in he/she personal information in the fulfillment site, thus saving user time, and increasing the likelihood that the user will complete the fulfillment process. However, transferring the user information may reveal personal user information to the fulfillment sites. Users themselves may indicate whether they would prefer their personal information to be transferred. In an alternative embodiment of the invention, user preferences regarding whether their personal information should be transferred to the fulfillment sites may be indicated as part of the general user preferences.

If the user has indicated that the user information should be transferred to the fulfillment site, the user may additionally select which portion of the personal information should be sent to the fulfillment site, or all of the information may be transferred. Users may then be transferred to the customized fulfillment site in step 1312. The appearance of the fulfillment site may depend on the particular fulfillment company. In one embodiment of the invention, transferring to the fulfillment site may be done in one window of the client interface 110, or in a portion of one window. In yet another embodiment of the invention, the user may need to exit system 100 in order to be transferred to the fulfillment site.

One or more transfers to the fulfillment sites may be recorded in the fulfillment database 108d in step 1314. After that, the process may terminate in step 1316, allowing users to complete their recalls or to return to system 100 and take advantage of other client interface functions.

A computer system for implementing system 100 as a computer program typically includes a main unit connected to both an output device which displays information to a user and an input device which receives input from a user. The main unit generally includes a processor connected to a memory system via an interconnection mechanism. The input device and output device also are connected to the processor and memory system via the interconnection mechanism.

It should be understood that one or more output devices may be connected to the computer system. Example output devices include a cathode ray tube (CRT) display, liquid crystal displays (LCD), printers, communication devices such as a modem, and audio output. It should also be understood that one or more input devices may be connected to the computer system. Example input devices include a keyboard, keypad, track ball, mouse, pen and tablet, communication device, and data input devices such as sensors. It should be understood the invention is not limited to the particular input or output devices used in combination with the computer system or to those described herein.

The computer system may be a general purpose computer system which is programmable using a computer programming language, such as C++, Java, or other language, such as a scripting language or assembly language. The computer system may also include specially programmed, special purpose hardware. In a general purpose computer system, the processor is typically a commercially available processor, of which the series x86 and Pentium processors, available from Intel, and similar devices from AMD and Cyrix, the 680X0 series microprocessors available from Motorola, the PowerPC microprocessor from IBM and the Alpha-series processors from Digital Equipment Corporation, are examples. Many other processors are available. Such a microprocessor executes a program called an operating system, of which WindowsNT, UNIX, DOS, VMS and OS8 are examples, which controls the execution of other computer programs and provides scheduling, debugging, input/output control, accounting, compilation, storage assignment, data management and memory management, and communication control and related services. The processor and operating system define a computer platform for which application programs in high-level programming languages are written.

A memory system typically includes a computer readable and writeable nonvolatile recording medium, of which a magnetic disk, a flash memory and tape are examples. The disk may be removable, known as a floppy disk, or permanent, known as a hard drive. A disk has a number of tracks in which signals are stored, typically in binary form, i.e., a form interpreted as a sequence of one and zeros. Such signals may define an application program to be executed by the microprocessor, or information stored on the disk to be processed by the application program. Typically, in operation, the processor causes data to be read from the nonvolatile recording medium into an integrated circuit memory element, which is typically a volatile, random access memory such as a dynamic random access memory (DRAM) or static memory (SRAM). The integrated circuit memory element allows for faster access to the information by the processor than does the disk. The processor generally manipulates the data within the integrated circuit memory and then copies the data to the disk when processing is completed. A variety of mechanisms are known for managing data movement between the disk and the integrated circuit memory element, and the invention is not limited thereto. It should also be understood that the invention is not limited to a particular memory system.

It should be understood the invention is not limited to a particular computer platform, particular processor, or particular high-level programming language. Additionally, the computer system may be a multiprocessor computer system or may include multiple computers connected over a computer network. It should be understood that each module (e.g. statistics engine, client user interface, etc.) in FIG. 1 may be separate modules of a computer program, or may be separate computer programs. Such modules may be operable on separate computers. Data (e.g. databases 108a-e) may be stored in a memory system or transmitted between computer systems. The invention is not limited to any particular implementation using software or hardware or firmware, or any combination thereof. The various elements of the system, either individually or in combination, may be implemented as a computer program product tangibly embodied in a machine-readable storage device for execution by a computer processor. Various steps of the process may be performed by a computer processor executing a program tangibly embodied on a computer-readable medium to perform functions by operating on input and generating output. Computer programming languages suitable for implementing such a system include procedural programming languages, object-oriented programming languages, and any combination of programming languages thereof.

Having now described several embodiments, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. A computer-implemented method of distributing product hazard information to users, said method comprising:
sorting user preferences for at least one user;
receiving product hazard information from at least one product hazard information source;
identifying at least one user to receive said product hazard information based on user preferences; and
making said product hazard information available to the at least one identified user.

2. The computer-implemented method of claim 1, further comprising processing said product hazard information.

3. The computer-implemented method of claim 2, wherein processing said product hazard information further comprises verifying said product hazard information.

4. The computer-implemented method of claim 2, wherein processing said product hazard information further comprises determining at least one category for said product hazard information, wherein the at least one category is determined based on at least one product identified in said product hazard information.

5. The computer-implemented method of claim 1, wherein said at least one user is presented with a personalized access site when said user accesses a system providing product hazard information.

6. The computer-implemented method of claim 5, further comprising registering said at least one user to access the system.

7. The computer-implemented method of claim 6, wherein registering said at least one user is performed before allowing said user to access the system.

8. The computer-implemented method of claim 6, further comprising requesting authentication information from the at least one user.

9. The computer-implemented method of claim 8, wherein requesting authentication information from the at least one user is performed before allowing said user to access the system.

10. The computer-implemented method of claim 1, further comprising accepting at least one user input prior to making said product hazard information available to the at least one identified user.

11. The computer-implemented method of claim 10, further comprising recording information related to making said product hazard information available to the at least one identified user in a database.

12. The computer-implemented method of claim 1, further comprising sending an alert regarding said product hazard information to the identified at least one user.

13. The computer-implemented method of claim 12, wherein sending an alert further comprises sending an electronic mail message to the identified at least one user.

14. The computer-implemented method of claim 12, wherein said alert comprises a link to said product hazard information message indicating that one or more notifications relevant to the identified at least one user are available.

15. The computer-implemented method of claim 14, wherein providing said product hazard information is performed after the at least one identified user accesses a system providing product hazard information, wherein system access is performed by following said link.

16. The computer-implemented method of claim 12, wherein said user preferences further comprise preferences for whether a user should receive notices regarding product hazard information identified for said user.

17. The computer-implemented method of claim 16, wherein said user preferences further comprise at least one of: a time when said notices should be sent out, a portion of a day when said notices should be sent out, an indication of when said notices should be sent out, preferences indicating notices regarding which product hazard information should be sent out.

18. The computer-implemented method of claim 16, wherein said user preferences further comprise preferences for categories of product hazard information regarding which notices should be sent out.

19. The computer-implemented method of claim 16, wherein said user preferences further comprise an indication of products for which alerts regarding available product hazard information should be sent out.

20. The computer-implemented method of claim 1, wherein user preferences for a user further comprise an indication of categories for which product hazard information should be presented to said user.

21. The computer-implemented method of claim 1, wherein user preferences for a user further comprise an indication of user's geographical location.

22. The computer-implemented method of claim 1, wherein user preferences for a user further comprise an indication of at least one geographical area of interest to the user, wherein product hazard information for products relevant to said at least one geographical area should be made available to the user.

23. The computer-implemented method of claim 22, further comprising an indication of product categories for which product hazard information should be made available to the user.

24. The computer-implemented method of claim 22, wherein user preferences further comprise an indication of granularity for said at least one geographical area.

25. The computer-implemented method of claim 1, further comprising:
determining at least one logged-in user from the at least one identified user; and
presenting said product hazard information to said at least one logged-in user from the at least one identified user.

26. The computer-implemented method of claim 25, further comprising recording information related to presenting said product hazard information to the at least one logged-in user from the at least one identified user in a database.

27. The computer-implemented method of claim 1, further comprising sending a notice regarding said product hazard information to the identified at least one user if the at least one user has not previously accessed said product hazard information.

28. The computer-implemented method of claim 27, further comprising recording information related to sending the notice to the at least one identified user in a database.

29. The computer-implemented method of claim 11, wherein said information related to presenting said product hazard information is stored in the database in memory.

30. The computer-implemented method of claim 29, further comprising preserving the database for at least a pre-set amount of time.

31. The computer-implemented method of claim 11, wherein each user from the at least one user has a unique identifier.

32. The computer-implemented method of claim 31, further comprising recording, for a user accessing the product hazard information, user's unique identifier in the database.

33. The computer-implemented method of claim 32, further comprising making at least a portion of information stored in the database available to a third party in response to a subpoena.

34. The computer-implemented method of claim 33, wherein the at least a portion of information stored in the database comprises identification information that identifies a user who accessed said product hazard information and a date and time of the access.

35. The computer-implemented method of claim 29, wherein the product hazard information has a unique identifier.

36. The computer-implemented method of claim 35, wherein said information related to presenting said product hazard information further comprises at least one of: a time of the presentation, a data of the presentation, a unique identifier of a user to whom the product hazard information was presented, and the unique identifier for the product hazard information.

37. The computer-implemented method of claim 1, further comprising:
modifying user preferences for a first user by the first user; and
storing information regarding modification of the user preferences for the first user in a database.

38. The computer-implemented method of claim 1, further comprising receiving product warning information from a second user.

39. The computer-implemented method of claim 38, wherein the product warning information is a report from the second user of potential problems related to a product.

40. The computer-implemented method of claim 38, further comprising verifying the product warning information.

41. The computer-implemented method of claim 38, further comprising:
identifying at least one third user to receive the product warning information based on user preferences; and
making the product warning information available to the identified at least one third user.

42. The computer-implemented method of claim 1, wherein making the product hazard information available to the identified at least one user comprises making the product hazard information available through at least one of a group including of: a website, a telephone, an electronic mail message, an instant message, and a television.

43. The computer-implemented method of claim 42, wherein making the product hazard information available further comprises making the product hazard information available simultaneously through two or more of the group.

44. The computer-implemented method of claim 42, wherein information regarding access to the product hazard information is recorded in a database, and wherein the information regarding access to the product hazard information further comprises an indication of a method of access.

45. The computer-implemented method of claim 1, further comprising authenticating the at least one identified user.

46. The computer-implemented method of claim 45, wherein the authentication is based on a username-password combination.

47. The computer-implemented method of claim 1, further comprising:
registering the at least one user; and
creating a set of preferences for the at least one user.

48. A method for administering a survey, the survey having a plurality of questions, the method comprising:
presenting, to at least one user, a single question of the survey, the single question soliciting an opinion of the user, and having at least one of a positive or negative response.

49. The method according to claim 48, further comprising maintaining a response distribution associated with the single question.

50. The method according to claim 49, further comprising presenting to the user, at least one other question, the at least one other question verifying the response distribution of the single question.

51. The method according to claim 50, wherein the at least one other question is a rephrasing of the single question wherein the at least one other question produces a response similar to a response to the single question.

52. The method according to claim 48, wherein the at least one of a positive or negative responses are yes or no, respectively.

53. The method according to claim 48, further comprising displaying the single question to the user in a user interface.

54. The method according to claim 53, wherein the user interface is a browser program that displays a markup language document including the single question.

55. The method according to claim 47, further comprising maintaining a list of one or more questions of the plurality of questions of the survey to which the user responded, the list being associated with a user ID associated with the user.

56. The method according to claim 47, further comprising maintaining a list of one or more questions of the plurality of questions of the survey to which the user has not responded, the list being associated with a user ID associated with the user.

57. The method according to claim 56, further comprising presenting to the user, at least one other question, the at least one other question being on the list of one or more questions to which the user has not responded.

58. The method according to claim 47, wherein the user is restricted to either one of the positive or negative response.
